(19) United States
(12) Patent Application Publication
(10) Pub. No.: US 2013/0071569 A1
(43) Pub. Date: Mar. 21, 2013

(54) METHOD OF FORMING A PATTERN ON THE SURFACE OF A SUBSTRATE

(71) Applicants: Igor Siretanu, Passac (FR); Jean-Paul Chapel, Bordeaux (FR); Carlos Drummond, Bordeaux (FR)

(72) Inventors: Igor Siretanu, Passac (FR); Jean-Paul Chapel, Bordeaux (FR); Carlos Drummond, Bordeaux (FR)

(73) Assignee: CENTRE NATIONAL DE LA RECHERCHE SCIENTIFIQUE, Paris (FR)

(21) Appl. No.: 13/635,653

(22) PCT Filed: Mar. 15, 2011
(86) PCT No.: PCT/FR2011/000139

§ 371 Date: Nov. 28, 2012

(30) Foreign Application Priority Data
Mar. 18, 2010 (FR) 1001078

(51) Int. Cl. B05D 5/00

(52) U.S. Cl. CPC B05D 5/00
USPC 427/282; 427/256

(57) ABSTRACT

A method of forming a pattern on the surface made of a hydrophobic macromolecular material of a substrate is provided, the method having a step of immersing at least said surface of the substrate in a solution that having at least 50% by volume of water and, optionally, one or more polar solvents having a dielectric constant greater than 30 and contains less than 0.0001 mol/L of dissolved gases and on source. The invention is particularly applicable in the electronics field.

The invention relates to a method for forming a pattern on the surface of a substrate, said surface being made of a hydrophobic macromolecular material.

Forming microscopic or nanoscale patterns, i.e. forming patterns having at least one dimension that is about a few tens of microns or nanometers in size, is of increasing interest with a view to the progress being made miniaturizing various devices such as integrated circuits, magnetic and mechanical circuits, semiconductors, integrated optical instruments, labs-on-chips, and in the field of micro or nanofluidics.

The patterns thus formed may be used to provide a wide variety of functions, including electrical, magnetic, optical, chemical and/or biological functions.

Lithography is the oldest known method for creating such patterns, in particular in a thin film deposited on a substrate.

In the fabrication of integrated circuits, photolithography consists in exposing two photoresist layers to a beam of energetic particles through a mask.

The particle beam modifies the chemical structure of the exposed regions of the film, which are then developed.

The exposed regions or the unexposed regions of the resist are then removed to reproduce the mask pattern on the surface of the thin film.

The pattern may also be printed by pressure into the desired surface of the substrate.

Patent application WO 00/21689 describes a lithographic method for creating patterns having at least one submicron-sized dimension on a substrate.

To do this, a mask is placed above and at a controlled distance from a film of a deformable macromolecular material.

The pattern is then created on the substrate by heating the substrate/polymer film/mask assembly to a temperature above the glass transition temperature of the material forming the polymer film.

Application WO 01/47003 describes a method for forming a pattern in a film deposited on a substrate, which method consists in placing a mask comprising the desired pattern above the film in which it is desired to create the pattern, the mask being made of a material having different dielectric properties to the film in which it is desired to form the pattern, and applying an electric field to the interface between the film and the mask so as to produce a structure in the film, and hardening the structure formed in this film so as to provide the film with the desired pattern.

However, all these methods are difficult to implement and require the use of many pieces of equipment and/or power sources and many reagents.

In contrast, the invention provides a very simple method for forming patterns on the surface of a substrate, said surface being made of a hydrophobic macromolecular material.

The method according to the invention consists in submerging the surface on which it is desired to form the pattern in a solution comprising at least 50 vol % water, optionally mixed with one or more polar solvents having a dielectric constant of 30 or more.

The solution must be a degassed solution, i.e. containing less than 0.0001 mol of dissolved gas per liter.

The dissolved gasses are for example O₂, N₂, CO₂ and more generally air.

The solution may be degassed using any desired means and in particular by placing the solution in a vacuum at a pressure of −8000 Pa (−60 mmHg) or less, preferably of −93325 Pa (−700 mmHg) or less, for at least thirty minutes.

In addition, this solution must contain a source of ions that dissolve in the solution. This soluble ion source may be a pH adjuster or a salt that dissolves in the solution, or else a surfactant that dissolves in the solution and transports ionic species.

This solution consists of at least 50 vol % water and, optionally, a solvent or a mixture of solvents that are liquid at the temperature at which the nanostructure will be formed.

Each solvent is a polar solvent and has a dielectric constant of 30 or more.

By way of an example of such solvents, mention will be made of N-methylpyrrolidone.

More preferably the solution consists only of water.

When the soluble ion source is a pH adjuster, it may, as those skilled in the art will know, be NaOH, KOH, HNO₃, HCl and acids and bases comprising Hofmeister-series ions, described for example by F. Hofmeister in Arch. Exp. Pathol. Pharmacol. 24, (1888) 247-260, and the salt may be a salt such as NaCl, KCl or salts comprising Hofmeister-series ions (F. Hofmeister, Arch. Exp. Pathol. Pharmacol. 24, (1888) 247-260) or mixtures of these salts.

The pH of the obtained solution may be between 1.5 and 12, the pH affecting the size of the reliefs formed on the surface.

However, the source of ions need not affect the pH. In this case, the ion source is a salt or a mixture of salts that dissolve(s) in the solution, which may then, in particular, have a neutral pH.

Particularly preferred examples of these salts include quaternary ammonium salts, for example tetrabutyl ammonium chloride or bromide or iodide or nitrate, and lithium salts such as, for example, lithium fluoride or bromide or iodide, and mixtures of two or more of these salts. The salts NaCl and/or KCl may also be used.

The ion source may also be a surfactant or a surfactant mixture.

An example of a surfactant that may be used as an ion source is didecyldimethylammonium bromide (DDAB).

As for the surface on which the pattern is to be formed, it must be made of a hydrophobic macromolecular material.

In addition, the material must be capable of undergoing, on its surface, to a depth of about 20 nm, deformation a few nanometers, more precisely between 1 and 10 nm, in height and width.

This “deformability” corresponds to a higher molecular mobility at the surface of this material.

Such materials are for example proteins; uncured amorphous thermoplastics having a water contact angle higher than 70° C., such as polystyrene (PS), polycarbonate (PC), polyethylene terephthalate (PET), polyetheretherketone (PEEK), polyphenylene ether (PPE), polyethylene imine (PEI), a perfluoroalkoxy (Teflon® PFA) or polyvinyl chloride (PVC); or two-component resins, such as polyurethane (PU) resins obtained by polymerizing polyols with isocyanates, and polyepoxide resins obtained by polymerizing epoxy resins with polyamines.

Mention may be made, among the isocyanates, of aromatic isocyanates such as diisocyanate (TDI) and diphenylmethane diisocyanate (MDI); aliphatic isocyanates such as 1,6-hexamethylene diisocyanate (HDI), 1-isocyanato-3-isocyanatomethyl-3,5,5-trimethylcyclohexane (isophorone diisocyanate, IPDI); and 4,4′-diisocyanato-dicyclohexylmethane (H12 MDI).

Mention may be made, among the polyols, of polycarbonate polyols, polycaprolactone polyols, polybutadiene polyols and polysulfide polyols.

Mention may be made, among the epoxides, of bisphenol-A diglycidyl ether.

Mention may be made, among the polyamines, of aromatic polyamines such as methylene dianiline (MDA), 4,4′-methylene-bis(3-chloro-2,6-diethylaniline) (MCDEA), diethyltoluene diamine (DETDA), 4,4′-methylene-bis(2-ethyl-6-methylaniline) (NMMEA), 4,4′-methylene-bis(2,6-diethylaniline) (MDEA) and 4,4′-methylene-bis(2-isopropyl-6-methylaniline).

Mention may also be made, by way of hydrophobic macromolecular materials, of the photoresist resin sold under the trade name EPON® SU-8, and of polydimethylsiloxane (PDMS).

Preferably polystyrene or PDMS will be used.

The surface may be a film of such a material deposited on a carrier, for example a carrier made of silicon or mica or any other material.

However, the substrate may itself be made entirely of the hydrophobic macromolecular material.

The surface may be flat or curved, convex or concave.

The surface can be the surface of particles made of a hydrophobic macromolecular material.

The surface of this material must however be deformable, to a depth of at least 20 nm.

The deformation creates the nanostructure, which may remain in place after the aqueous solution has been removed from the surface, or which may have to be “set” after it has formed.

For uncured polymers, the deformation may be obtained by curing them.

In order to create patterns with the desired layout, the invention proposes to deposit a mask made of a material resistant to the solution with the desired pH, and comprising a negative or positive of the desired pattern, as required, so as to create regions that will not make contact with the aqueous solution.

The temperature of the solution may range from room temperature, i.e. a temperature of between 20 and 25° C., up to a temperature below the boiling point of the solution, at the pressure at which the nanostructure is formed.

For example, when the solution is water, it will be possible to employ a temperature of up to 150° C. by forming the nanostructure in an autoclave at a pressure of 500,000 Pa (5 bar).

The temperature, just like the pH, allows the height and width of the reliefs obtained to be varied, the reliefs appearing in regions exposed to the solution.

The length of time the surface and the solution remain in contact also allows the height and width of the reliefs obtained to be varied.

Thus, the invention provides a method for forming a pattern on the surface of a substrate, characterized in that:
said surface is made of a hydrophobic macromolecular material; and
it comprises a step a) of submerging at least said surface of the substrate in a solution comprising at least 50 vol % water and, optionally, one or more polar solvents having a dielectric constant above 30, and containing less than 0.0001 mol/l of dissolved gas and an ion source.

In a preferred variant, the solution consists of water and the ion source.

In this case, step a) is carried out at a pH of between 1.5 and 12 inclusive, at a temperature of between 20° C. and 150° C. inclusive and a pressure of between 100,000 and 500,000 Pa (1 and 5 bar).

In every variant of a first implementation of the method of the invention, the substrate consists of a carrier covered with a layer made of a hydrophobic macromolecular material or of particles of a hydrophobic macromolecular material.

In every variant of a second implementation of the method of the invention, the substrate is entirely made of a hydrophobic macromolecular material.

Said hydrophobic macromolecular material is preferably chosen from polystyrene (PS) and polydimethylsiloxane (PDMS).

According to a variant of the method of the invention, before step a) has been carried out, said surface of the substrate is covered with a mask comprising a positive or negative of the pattern that it is desired to form on said surface.

Without wishing to be bound by any theory, the inventors believe that reliefs are created by the method of the invention because, as is well known, a low-density water layer (comprising cavities and nanobubbles) forms when water makes contact with a hydrophobic interface, and because hydroxide ions (OH⁻) or hydronium ions (H₃O⁺) are preferably adsorbed at this interface where the water density is lower, depending on the pH of the solution. Thus, the inventors have found that the ions and chemical species that are best adsorbed at this interface have the greatest structuring power.

The step for removing gasses, such as air, O₂, N₂ and CO₂, dissolved in the solution (the bubbles) via the degassing step reduces the size of the regions that do not make contact with the water, and may even eliminate them completely.

The charged hydroxide (OH⁻) or hydronium (H₃O⁺) ions can then be more strongly adsorbed by the surface of the hydrophobic macromolecular material, thus creating an extremely high local electric field of about 1×10⁷ V/m.

Consequently, if the surface making contact with the water is deformable, the electrostatic force generated by the high electric field will create reliefs in the plane of the surface.

Laplace pressure (surface energy), tending to keep the interface as flat as possible, will of course balance this force.

The instability that develops at this interface is known as electrohydrodynamic instability (EHI).

The EHI is increased by using degassed water.

The strength of this instability depends on the pH.

The concentration of OH⁻ or H₃O⁺ ions determines the amount of charge that appears at the interface for a given pH.

For a neutral pH, where the concentration of the two types of ion (OH⁻ and H₃O⁺) is not very high, any salts added, such as NaCl and KCl; quaternary ammonium salts (in particular those mentioned above); lithium salts (in particular those mentioned above); mixtures of two or more of such salts and a surfactant or a surfactant mixture, in particular DDAB, will act in a similar way. Salts such as NaCl and KCl may also be used. However, quaternary ammonium salts and lithium salts and their mixtures will preferably be used, these salts having better structuring properties than NaCl and KCl.

In order to allow the invention to be better understood, several implementations thereof will now be described below by way of purely illustrative and nonlimiting example.

In these examples, AFM images of the topography of the surface over an area of 1 μm² were used to measure surface roughness.

The value obtained was the quadratic mean (RMS) of the heights of any roughness on this surface.

### EXAMPLE 1

Thin polystyrene films about 200 nm in thickness having an RMS roughness of less than 1 to 2 nm in depth were formed on a silicon wafer with a native oxide layer, which films were silanized beforehand in order to prevent any dewetting of the thin PS film.

The thin polystyrene films were produced using a solution comprising 5 wt % polystyrene having a molar weight of 250 kg/mol in toluene by spin coating at a rotation speed of between 1500 and 5000 rpm.

The films were then baked overnight at 160° C., i.e.

above the glass transition temperature of polystyrene, so as to relax any residual stress produced during the spin coating and to remove the residual toluene.

The uniformity of the reference layer was checked using an atomic force microscope (AFM).

These surfaces were then submerged in various aqueous solutions produced using nondegassed water and having a pH ranging from pH 1.5 (acidified with nitric acid HNO₃) to pH 12 (basified with sodium hydroxide NaOH).

The surfaces of the polystyrene films remained in contact with the solution for between 5 minutes and 24 hours.

Images, obtained by AFM, were taken of the surfaces dried and in air.

As expected, treatment with nondegassed aqueous solutions did not change the texture/roughness of the polystyrene surface relative to the untreated reference sample.

The same type of experiment was carried out with solutions degassed beforehand (placed in an ordinary vacuum for 2 hours at a pressure of about 93325 Pa (−700 mmHg)).

A nanostructure was then observed to appear in relief, at both low and high pHs.

Thus, at a pH of 1.5, reliefs that were 2.6 nm in height and 23 nm in width were obtained.

A pH of 2.5 produced reliefs that were 1.3 nm in height and 15 nm in width.

A pH of 7.0 produced reliefs that were 0.6 nm in height and 10 nm in width.

A pH of 9.2 produced reliefs that were 1.4 nm in height and 15 nm in width.

A pH of 11.3 produced reliefs that were 2.2 nm in height and 40 nm in width.

The nanostructure created was durable in air over a number of weeks.

### EXAMPLE 2

Thin polystyrene films formed as in example 1 were heated to 65° C. and submerged for 5 minutes in a solution of pH 1.5 degassed beforehand and heated to 65° C.

The AFM micrographs obtained showed reliefs that were taller (8.5 nm) and wider (85 nm) than those obtained under the same conditions with a degassed solution but at room temperature.

### EXAMPLE 3

Next, immediately after their fabrication, samples obtained using the method described in example 1 were cured with UV (300 nm wavelength).

After one month the structures in relief had not disappeared or relaxed.

### EXAMPLE 4

Substrates covered with a thin polystyrene film, formed as in example 1, were fabricated.

These substrates were submerged in an aqueous solution of neutral pH (pH=5.6), i.e. containing no pH adjuster but 0.03 M/l of NaCl.

Reliefs were also generated, the height and width of which reliefs increased with submersion time.

### Comparative Example

Polystyrene is a hydrophobic material with a water contact angle of about 90 degrees.

To demonstrate that the method according to the invention can be applied only to hydrophobic materials, a polystyrene film prepared as in example 1 was irradiated with UV (200 nm wavelength) for 15 minutes.

The surface of this film was thus made hydrophilic: water contact angle smaller than 30 degrees.

The surface was then submerged in an acidic solution, the water of which had been degassed for 30 minutes.

No structure in relief was observed to form.

### EXAMPLE 5

This example shows that it is possible to regenerate the nanostructured surfaces in the case where the nanostructures have not been set, for example by curing.

In this case it is possible to use a heat treatment or a solvent to smooth the surface again.

Thus, in this example, the surface of a sample obtained according to example 1 was baked at 100° C. for 2 hours.

The formed nanostructure relaxed and even disappeared over time.

Next, the surface regenerated in this way was again submerged in a degassed acidic aqueous solution and a new nanostructure was formed.

The same experiment was performed again but this time the nanostructured surface was subjected to saturated toluene vapor for 15 minutes.

Once again, the nanostructure relaxed and disappeared as a function of time.

The regenerated surface could then once more be nanostructured using the same acid treatment.

### EXAMPLE 6

### Nanostructuring of a Polydimethylsiloxane (PDMS) Substrate

PDMS is widely used as a molding material in soft lithography, which makes it one of the most widely used materials in high-flow systems such as microfluidic chips.

A PDMS substrate was prepared by pouring Sylgard 184 (from Dow) and a curing agent (10:1) into a Petri dish.

The mixture was vigorously mixed and placed in a vacuum for 20 minutes so as to remove any bubbles.

This grade of PDMS is known to cure completely in 4 hours at 65° C.

Subsequently, the Petri dish was placed in an oven for 1 hour at 60° C. so as to obtain a hard layer.

The Petri dish was then submerged in a degassed acidified aqueous solution of pH 1.5 and kept in the oven for 3 hours so as to completely cure the PDMS.

Images were then taken, using an AFM, of a PDMS reference substrate that had not been treated with the degassed aqueous solution, and of the treated substrate.

The surface of the reference sample was smooth having an (RMS) roughness of 0.4 nm, and the surface of the treated sample contained superficial reliefs giving it an (RMS) roughness of 1.5 nm.

### EXAMPLE 7

### Nanostructuring of Colloids

The method of the invention may also be applied to particles (discontinuous materials).

Thus, monodispersed polystyrene balls (0.4 μm in size) were deposited, by dip coating in a concentrated aqueous solution (10 g/l), on the surface of a smooth mica substrate.

Images taken by AFM showed that there were no reliefs on the bare surface of these polystyrene spheres.

The substrate was then submerged for 5 minutes at 25° C. in a degassed aqueous solution of pH 1.5 acidified with nitric acid.

An AFM image of this substrate showed that, after the treatment, the polystyrene spheres contained superficial reliefs having a height of 0.5 nm and a width of 13 nm.

The same experiment was carried out using the same solution as above but heated to 65° C.

The reliefs formed were, as expected, taller (1.0 nm) and wider (25 nm) than for the sample treated at room temperature (25° C.)

### EXAMPLE 8

### Multiscale Nanostructuring

This example demonstrates that it is possible to use water-based nanostructuring to create multiscale roughness on surfaces that may be used in various technologies such as tribology, adhesion or fluidization technologies, etc.

In a first step, thin polystyrene films spun coated onto silicon substrates, the surfaces of which were cured beforehand, were given a superficial nanostructure using the osmotic stress technique described by J. Y. Chung, A. J. Nolte, et al. (2009) in “Diffusion-Controlled, Self-Organized Growth of Symmetric Wrinkling Patterns.” Advanced Materials 21 (13): 1358-1362.

Concentric rings of polystyrene were obtained.

A second roughness was generated in a second step by applying the same technique to the rings formed in the first step.

Finally, a third roughness was generated by submerging the doubly structured surface obtained beforehand in a degassed acid solution.

The AFM image obtained of this sample showed that a third roughness was obtained.

### EXAMPLE 9

### Creating a Pattern Via Contact With a Mask

A PDMS solution was poured onto the surface of a silicon wafer that had been structured beforehand with grooves, squares and rectangles using a conventional photoresist-based lithography process.

After thermal curing (4 hours at 75° C.), the cured PDMS layer was removed from the silicon wafer.

Its surface clearly contained a negative of the pattern on the silicon wafer.

This PDMS mask was then pressed against the surface of a thin polystyrene film and the assembly was submerged in a degassed acidic aqueous solution.

The aqueous solution wetted the regions of the polystyrene surface that did not make contact with the mask.

After 5 minutes, strips, squares and rectangles corresponding to the original pattern were easily formed in relief on the surface of the polystyrene film.

1. A method for forming a pattern on the surface of a substrate, said surface being made of a hydrophobic macromolecular material, the method comprising:
a) submerging at least said surface of the substrate in a solution comprising at least 50 vol % water and one or more polar solvents having a dielectric constant above 30, and containing less than 0.0001 mol/l of dissolved gas and an ion source.

2. The method as claimed in claim 1, wherein the ion source is an acid or a base.

3. The method as claimed in claim 1, wherein the ion source is a salt of an acid or a base.

4. The method as claimed in claim 1, wherein the ion source is chosen from NaCl, KCl, quaternary ammonium salts, lithium salts and mixtures of at least two of these salts.

5. The method as claimed in claim 1, wherein the ion source is a surfactant or a surfactant mixture and preferably didecldimethylammonium bromide.

6. The method as claimed in claim 1, wherein the solvent is water.

7. The method as claimed in claim 6, wherein step a) is carried out at a pH of between 1.5 and 12 inclusive at a temperature of between 20° C. and 150° C. inclusive and at a pressure of between 100,000 and 500,000 Pa.

8. The method as claimed in claim 1, wherein the substrate consists of a carrier covered with a layer made of a hydrophobic macromolecular material or of nanoparticles of a hydrophobic macromolecular material.

9. The method as claimed in claim 1, wherein the substrate is entirely made of a hydrophobic macromolecular material.

10. The method as claimed in claim 1, wherein said hydrophobic macromolecular material comprises polystyrene (PS) and polydimethylsiloxane (PDMS).

11. The method as claimed in claim 1, wherein, before step a) has been carried out, said surface of the substrate is covered with a mask comprising a positive or negative of the pattern that it is desired to form on said surface.

12. The method of claim 1, wherein the ion source is chosen from quaternary ammonium salts, lithium salts and mixtures of at least two of these salts
